(19) United States
(12) Patent Application Publication
(10) Pub. No.: US 2026/0210472 A1
(43) Pub. Date: Jul. 23, 2026

(54) SOCKET AND COUPLING ASSEMBLY

(71) Applicant: Jentech Precision Industrial Co., LTD., TAOYUAN CITY (TW)

(72) Inventors: Shan Yong CHENG, TAOYUAN CITY (TW); Chin Jui YU, TAOYUAN CITY (TW); Yu Yuan TAI, TAOYUAN CITY (TW); Wei Chi LIN, TAOYUAN CITY (TW); Po Jen CHEN, TAOYUAN CITY (TW); Yi Chen TSAI, TAOYUAN CITY (TW); Yu Ting HSU, TAOYUAN CITY (TW)

(21) Appl. No.: 19/448,122

(22) Filed: Jan. 14, 2026

Related U.S. Application Data
(60) Provisional application No. 63/746,265, filed on Jan. 17, 2025.

(30) Foreign Application Priority Data
Apr. 24, 2025 (TW) 114115602
Nov. 26, 2025 (TW) 114146284

(51) Int. Cl. F16L 37/12; F16L 37/32

(52) U.S. Cl. CPC F16L 37/1225; F16L 37/32

(57) ABSTRACT

A socket includes a socket main body and a stem. The socket main body has a cavity, a front opening and a rear opening located on two opposite ends of the cavity. The socket main body further has a through slot runs through the socket main body. The stem includes a stem body, a stem head, arc-shaped supporting bones, and an abutting bottom portion. Each of the arc-shaped supporting bones extends away from the stem body in an axial direction and a radial direction of the socket main body. The abutting bottom portion is connected to the arc-shaped supporting bones. Every two of the arc-shaped supporting bones and the abutting bottom portion jointly define a fluid passageway opening.

### CROSS-REFERENCE TO RELATED APPLICATION

This application claims priority to U.S. Provisional Application Serial Number 63/746,265 filed January 17, 2025, Taiwan Application Serial Number 114115602, filed April 24, 2025, and Taiwan Application Serial Number 114146284, filed November 26, 2025, the disclosures of which are incorporated herein by reference in their entireties.

### BACKGROUND

### Field of Invention

The present invention relates to a socket and a coupling assembly, especially a quick-released socket and a coupling assembly.

### Description of Related Art

For servers, improving cooling efficiency has become a critical objective. In particular, the growing adoption of water-cooling technologies has driven an increasing demand for manufacturers to implement water-cooling systems. Among these systems, quick-release water-cooling connectors are essential components. However, the water-cooling connector is the most leakage-prone component in the entire water-cooling system. In addition, there is currently no existing coupling assembly that simultaneously satisfies both a tightly engaged connection between connectors (i.e., the socket and the plug) and ease of user operation.

Therefore, how to propose a socket and a coupling assembly that can solve the aforementioned problems is one of the problems that the industry is currently eager to invest in research and development resources to solve.

### SUMMARY

In view of this, one purpose of the present disclosure is to provide a socket and a coupling assembly that can solve the aforementioned problems.

In order to achieve the above objective, in accordance with an embodiment of the present disclosure, a socket has a cavity, a front opening and a rear opening located at opposite ends of the cavity. The socket includes a socket main body and a stem. The socket main body has a through slot running through the socket main body. The front opening defines a front end surface of the socket main body. The stem is disposed in the cavity. The stem includes a stem body, a stem head, a plurality of arc-shaped supporting bones, and an abutting bottom portion. The stem body is elongated in an axial direction of the socket main body. The stem head is disposed at an end of the stem body and has a stem head groove. The arc-shaped supporting bones extend from the other end of the stem body. Each of the arc-shaped supporting bones extends away from the stem body in the axial direction and a radial direction of the socket main body. The abutting bottom portion is connected to the arc-shaped supporting bones. Every two of the arc-shaped supporting bones and the abutting bottom portion jointly define a fluid passageway opening.

In one or more embodiments of the present disclosure, the socket further includes a socket rear terminal and a label ring. The socket rear terminal is connected to the socket main body. The label ring is disposed on the socket rear terminal and is located between the socket rear terminal and the socket main body.

In one or more embodiments of the present disclosure, the socket main body further has a clip ring groove recessed from an inner surface of the socket main body.

In one or more embodiments of the present disclosure, the socket further includes a pressing part and a clip ring. The pressing part is disposed on the socket main body and is movably accommodated in the through slot. The clip ring is disposed on the socket main body and is movably accommodated in the clip ring groove. The clip ring includes an elastic portion located outside the cavity and an engaging ring portion located inside the cavity. The elastic portion has opposite ends arranged along the axial direction of the socket main body. An end of the elastic portion abuts against the pressing part and the other end of the elastic part abuts against an outer surface of the socket main body.

In one or more embodiments of the present disclosure, the pressing part includes a pressing main body, a tongue portion, a latch, and an expanding portion. The pressing main body is located over the clip ring. The tongue portion extends from the pressing main body and is located over the elastic portion. The latch extends from the pressing main body and is engaged with the socket main body. The expanding portion is located at an end of the latch. A diameter of the expanding portion is greater than a diameter of the latch.

In one or more embodiments of the present disclosure, the socket main body further includes an engaging groove accommodating the latch and the expanding portion.

In one or more embodiments of the present disclosure, the pressing part has an arc surface located on a side of the pressing part away from the socket main body.

In one or more embodiments of the present disclosure, the socket further includes a first rubber ring, a second rubber ring, and a third rubber ring. The first rubber ring and a second rubber ring are disposed on an inner surface of the socket main body. A distance between the first rubber ring and the front end surface is less than a distance between the second rubber ring and the front end surface. The third rubber ring is disposed in the stem head groove. A distance between the third rubber ring and the front end surface is less than the distance between the second rubber ring and the front end surface.

In one or more embodiments of the present disclosure, the arc-shaped supporting bones form a domed surface on a side thereof away from the stem body. The domed surface is located between the stem body and the abutting bottom portion.

In one or more embodiments of the present disclosure, the stem further includes a cone body disposed at an end of the stem body connected to the arc-shaped supporting bones and extending away from the stem body. An apex of the cone body is located at an end of the cone body away from the stem body.

In order to achieve the above objective, in accordance with an embodiment of the present disclosure, a coupling assembly includes a socket and a plug. The socket has a cavity, a front opening and a rear opening located at opposite ends of the cavity. The socket includes a socket main body and a stem. The socket main body has a through slot running through the socket main body. The front opening defines a front end surface of the socket main body. The stem is disposed in the cavity. The stem includes a stem body elongated in an axial direction of the socket main body, a stem head disposed at an end of the stem body and having a stem head groove, a plurality of arc-shaped supporting bones extending from the other end of the stem body, and an abutting bottom portion connected to the arc-shaped supporting bones. Each of the arc-shaped supporting bones extends away from the stem body in the axial direction and a radial direction of the socket main body. Every two of the arc-shaped supporting bones and the abutting bottom portion jointly define a fluid passageway opening. The plug is coupled with the socket. The plug includes a plug main body, a circumferential hook, and a circumferential engaging groove. The plug main body is accommodated in the cavity of the socket main body. The circumferential hook protrudes from an outer surface of the plug main body. The circumferential engaging groove is located behind the circumferential hook.

In one or more embodiments of the present disclosure, the socket further includes a socket rear terminal and a label ring. The socket rear terminal is connected to the socket main body. The label ring is disposed on the socket rear terminal and is located between the socket rear terminal and the socket main body.

In one or more embodiments of the present disclosure, the socket main body further has a clip ring groove recessed from an inner surface of the socket main body.

In one or more embodiments of the present disclosure, the socket further includes a pressing part and a clip ring. The pressing part is disposed on the socket main body and is movably accommodated in the through slot. The clip ring is disposed on the socket main body and is movably accommodated in the clip ring groove. The clip ring includes an elastic portion located outside the cavity and an engaging ring portion located inside the cavity. The elastic portion has opposite ends arranged along the axial direction of the socket main body. An end of the elastic portion abuts against the pressing part and the other end of the elastic part abuts against an outer surface of the socket main body.

In one or more embodiments of the present disclosure, the pressing part includes a pressing main body, a tongue portion, a latch, and an expanding portion. The pressing main body is located over the clip ring. The tongue portion extends from the pressing main body and is located over the elastic portion. The latch extends from the pressing main body and is engaged with the socket main body. The expanding portion is located at an end of the latch. A diameter of the expanding portion is greater than a diameter of the latch.

In one or more embodiments of the present disclosure, the socket main body further includes an engaging groove accommodating the latch and the expanding portion.

In one or more embodiments of the present disclosure, the pressing part has an arc surface located on a side of the pressing part away from the socket main body.

In one or more embodiments of the present disclosure, the socket further includes a first rubber ring, a second rubber ring, and a third rubber ring. The first rubber ring and a second rubber ring are disposed on an inner surface of the socket main body. A distance between the first rubber ring and the front end surface is less than a distance between the second rubber ring and the front end surface. The third rubber ring is disposed in the stem head groove. A distance between the third rubber ring and the front end surface is less than the distance between the second rubber ring and the front end surface.

In one or more embodiments of the present disclosure, the arc-shaped supporting bones form a domed surface on a side thereof away from the stem body. The domed surface is located between the stem body and the abutting bottom portion.

In one or more embodiments of the present disclosure, the stem further includes a cone body disposed at an end of the stem body connected to the arc-shaped supporting bones and extending away from the stem body. An apex of the cone body is located at an end of the cone body away from the stem body.

In summary, in the socket and the coupling assembly of the present disclosure, since the two ends of the elastic portion of the clip ring respectively abut against the socket main body and the pressing part, the engaging ring portion can move along with the pressing part under the positional limitation of the clip ring groove when the user presses or releases the pressing part, and the engaging ring portion returns to its original position when the pressing part is released, thereby securely being engaged with the plug. In the socket and the coupling assembly of the present disclosure, since the socket includes a first rubber ring located in front of the socket main body, when the plug main body enters the cavity of the socket main body, it can be limited by the first rubber ring, thereby facilitating the alignment of the plug main body with the sleeve inside the cavity. In the socket and the coupling assembly of the present disclosure, since the distance between the third rubber ring and the front end surface of the socket main body is less than the distance between the second rubber ring and the front end surface of the socket main body, the second rubber ring and the third rubber ring are axially positioned on different planes. As such, when the sleeve moves axially between the second rubber ring and the third rubber ring, the resistance applied to the sleeve by the second rubber ring and the third rubber ring is relatively low, thereby reducing the user’s effort during coupling of the socket and the plug. In the socket and the coupling assembly of the present disclosure, since the pressing part has an arc surface located on a side thereof away from the socket main body, user comfort can be enhanced when the pressing part is pressed by a fingertip. In the socket and the coupling assembly of the present disclosure, since the arc-shaped supporting bones of the stem extend outward in both the radial direction and the axial direction, fluid (e.g., coolant) flowing through the cavity encounters reduced resistance, thereby increasing the flow coefficient. In conclusion, the socket and coupling assembly of the present disclosure not only ensures a secure engagement between the socket and the plug, but also enhances user convenience during plug-and-unplug operations.

It is to be understood that both the foregoing general description and the following detailed description are by examples, and are intended to provide further explanation of the invention as claimed.

### BRIEF DESCRIPTION OF THE DRAWINGS

The invention can be more fully understood by reading the following detailed description of the embodiment, with reference made to the accompanying drawings as follows:

FIG. 1 is a perspective view of a socket in accordance with an embodiment of the present disclosure;

FIG. 2 is an exploded view of the socket in accordance with an embodiment of the present disclosure;

FIG. 3 is a perspective view of a pressing part in accordance with an embodiment of the present disclosure;

FIG. 4 is a cross-sectional view of the pressing part based on a section 4-4 of FIG. 3 in accordance with an embodiment of the present disclosure;

FIG. 5 is a perspective view of a stem in accordance with an embodiment of the present disclosure;

FIG. 6 is a perspective view of the stem in accordance with an embodiment of the present disclosure;

FIG. 7 is a sided view of the stem in accordance with an embodiment of the present disclosure;

FIG. 8 is a rear view of the stem in accordance with an embodiment of the present disclosure;

FIG. 9 is a perspective view of a stem in accordance with another embodiment of the present disclosure;

FIG. 10 is a perspective view of the stem in accordance with another embodiment of the present disclosure;

FIG. 11 is a sided view of the stem in accordance with another embodiment of the present disclosure;

FIG. 12 is a rear view of the stem in accordance with another embodiment of the present disclosure;

FIG. 13 is a front view of the socket in accordance with an embodiment of the present disclosure;

FIG. 14 is a sided view of the socket in accordance with an embodiment of the present disclosure;

FIG. 15 is a cross-sectional view of the socket based on a section 15-15 of FIG. 1 in accordance with an embodiment of the present disclosure;

FIG. 16 is a cross-sectional view of the socket based on a section 16-16 of FIG. 1 in accordance with an embodiment of the present disclosure;

FIG. 17 is a perspective view of a coupling assembly in accordance with an embodiment of the present disclosure; and

FIG. 18 is a cross-sectional view of the coupling assembly based on a section 18-18 of FIG. 17 in accordance with an embodiment of the present disclosure.

### DETAILED DESCRIPTION

Hereinafter, a plurality of embodiments of the present disclosure will be disclosed in diagrams. For the sake of clarity, many details in practice will be described in the following description. However, it should be understood that these details in practice should not limit present disclosure. In other words, in some embodiments of present disclosure, these details in practice are unnecessary. In addition, for simplicity of the drawings, some conventionally used structures and elements will be shown in a simple schematic manner in the drawings. The same reference numbers are used in the drawings and the description to refer to the same or like parts.

Hereinafter, the structure and function of each component included in a socket 100 of this embodiment and the connection relationship between the components will be described in detail.

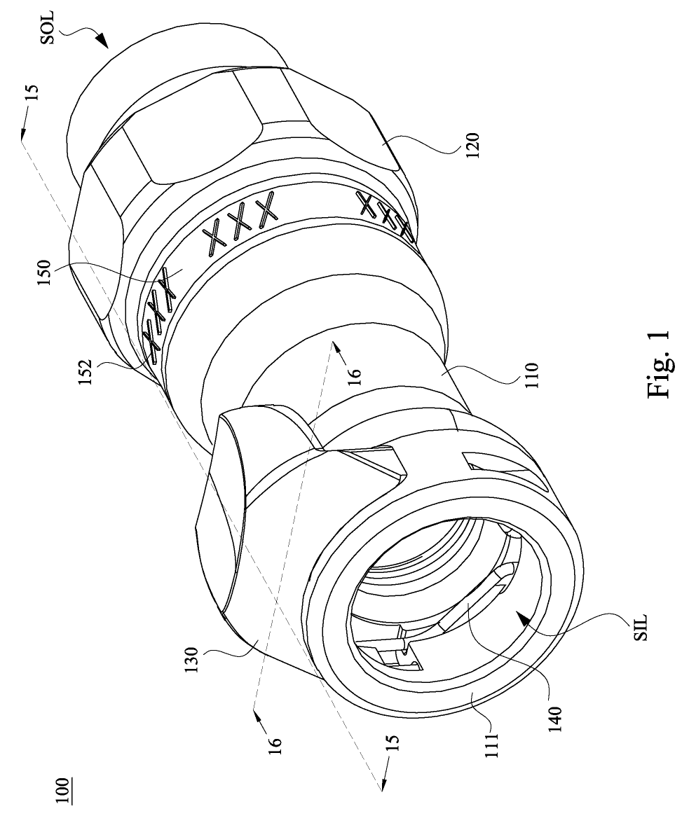

Reference is made to FIG. 1. FIG. 1 is a perspective view of a socket 100 in accordance with an embodiment of the present disclosure. As shown in FIG. 1, in this embodiment, the socket 100 includes a socket main body 110, a socket rear terminal 120, a pressing part 130, a clip ring 140, and a label ring 150. The socket 100 has a cavity. The socket 100 further includes a front opening SIL and a rear opening SOL located at opposite ends of the cavity. The front opening SIL defines a front end surface 111 of the socket main body 110. The rear opening SOL is located at an end of the socket rear terminal 120. The cavity of the socket 100 is elongated along an axial direction of the socket main body 110. The socket rear terminal 120 is connected to the socket main body 110. Specifically, the socket rear terminal 120 is located behind the socket main body 110. The pressing part 130 is disposed on the socket main body 110. The pressing part 130 is movable relative to the socket main body 110. In some embodiments, the pressing part 130 moves relative to the socket main body 110 along a radial direction of the socket main body 110. The clip ring 140 is disposed on the socket main body 110 and located under the pressing part 130. The clip ring 140 extends generally along a circumferential direction of the socket main body 110. The clip ring 140 is configured to be driven by the pressing part 130 to move relative to the socket main body 110 along the radial direction. The label ring 150 is disposed on the socket rear terminal 120 and located between the socket main body 110 and the socket rear terminal 120. The label ring 150 extends along a circumferential direction of the socket main body 110. Specifically, the label ring 150 is sleeved around an outer side of the socket rear terminal 120 and connected between the socket main body 110 and the socket rear terminal 120. In some embodiments, the label ring 150 includes a convex portion 152. The convex portion 152 protrudes from a surface of the label ring 150.

In some embodiments, the socket main body 110, the socket rear terminal 120, and the clip ring 140 may be made of, for example, stainless steel or other suitable rigid materials.

In some embodiments, the pressing part 130 may be made of, for example, plastic or other suitable insulating materials.

In some embodiments, the label ring 150 may be made of plastic, rubber, or other suitable materials.

In some embodiments, a material of the pressing part 130 is different from a material of the clip ring 140.

In some embodiments, the convex portion 152 may include arbitrary text or patterns, and the present disclosure is not intended to limit the style of the convex portion 152.

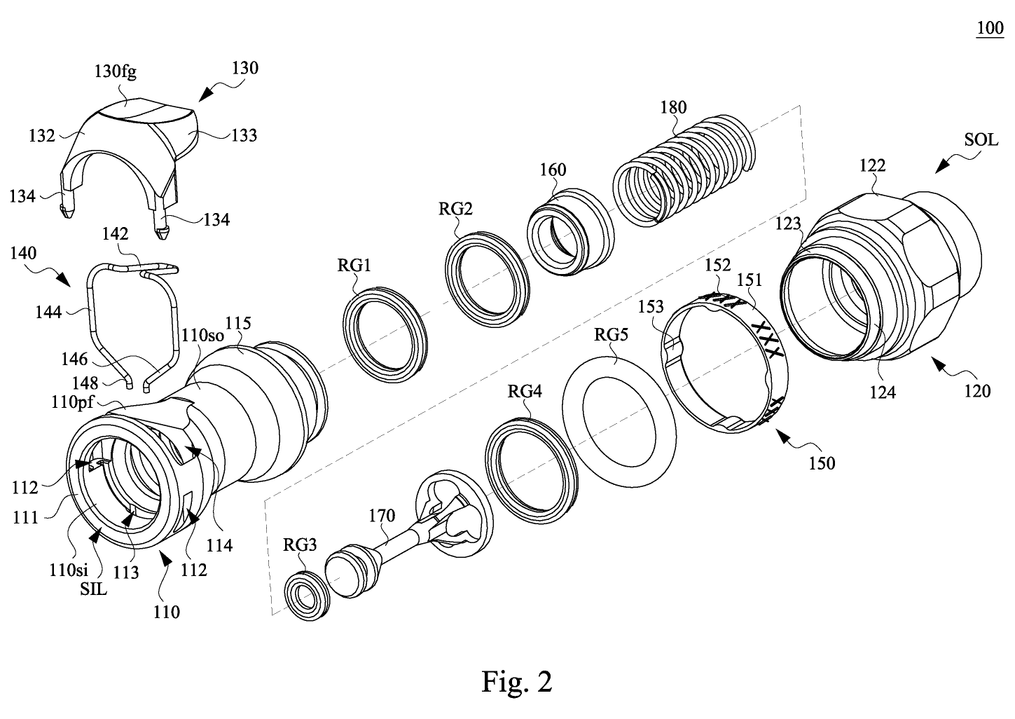

Reference is made to FIG. 2. FIG. 2 is an exploded view of the socket 100 in accordance with an embodiment of the present disclosure. As shown in FIG. 2, in this embodiment, the socket 100 further includes a sleeve 160, a stem 170, a spring 180, a first rubber ring RG1, a second rubber ring RG2, a third rubber ring RG3, a fourth rubber ring RG4, and a fifth rubber ring RG5. The socket main body 110 has an inner surface 110si, an outer surface 110so, and a horizontal surface 110pf. The inner surface 110si and the outer surface 110so extend in the axial direction and a circumferential direction of the socket main body 110. The horizontal surface 110pf is a portion of the outer surface 110so. The socket main body 110 further includes an engaging groove 112, a clip ring groove 113, a through slot 114, and an eaves portion 115. The engaging groove 112 is recessed from the outer surface 110so of the socket main body 110 and extends along the circumferential direction of the socket main body 110, and an end of the engaging groove 112 communicates with the cavity. The clip ring groove 113 is recessed from the inner surface 110si of the socket main body 110 and is configured to accommodate the clip ring 140. The through slot 114 runs through the socket main body 110 and is configured to accommodate the pressing part 130. The eaves portion 115 protrudes outward from the outer surface 110so of the socket main body 110. The socket rear terminal 120 includes a polygonal structure 122, a tapering portion 123, and a tapering circumferential surface 124. The polygonal structure 122 defines a maximum width of the socket rear terminal 120 in the axial direction. In some embodiments, the polygonal structure 122 may have, for example, a nut shape. The tapering portion 123 extends from the polygonal structure 122, and a diameter of the tapering portion 123 gradually decreases along the axial direction toward the socket main body 110. The tapering circumferential surface 124 extends from the polygonal structure 122 and is located between the polygonal structure 122 and the tapering portion 123. In some embodiments, a diameter of the tapering circumferential surface 124 and the diameter of the tapering portion 123 are both smaller than a diameter of the polygonal structure 122.

Reference is made again to FIG. 2. As shown in FIG. 2, in this embodiment, the pressing part 130 is movably accommodated in the through slot 114. The pressing part 130 has an arc surface 130fg and includes a pressing main body 132, a tongue portion 133, and a latch 134. The tongue portion 133 extends axially from the pressing main body 132. The latch 134 extends radially from the pressing main body 132. The latch 134 is engaged with the socket main body 110. Specifically, the engaging groove 112 is configured to accommodate a portion of the latch 134. The arc surface 130fg is located at a top of the pressing part 130. Specifically, the arc surface 130fg is located on a side of the pressing part 130 away from the socket main body 110. In some embodiments, the arc surface 130fg is defined by an edge portion of the pressing main body 132 and an edge portion of the tongue portion 133. In some embodiments, the arc surface 130fg is ergonomically designed. For example, the arc surface 130fg may be conformal to a human fingertip. This allows the user to feel comfortable when pressing on the arc surface 130fg of the pressing part 130 with a fingertip.

Reference is made again to FIG. 2. As shown in FIG. 2, in this embodiment, the clip ring 140 is movably accommodated in the clip ring groove 113. The clip ring 140 includes an elastic portion 142, an upper embedded ring portion 144, an engaging ring portion 146, and a lower embedded ring portion 148. The elastic portion 142 is connected to the upper embedded ring portion 144. The upper embedded ring portion 144 is connected between the elastic portion 142 and the engaging ring portion 146. The engaging ring portion 146 is connected between the upper embedded ring portion 144 and the lower embedded ring portion 148. Specifically, the elastic portion 142 has opposite ends arranged along the axial direction of the socket main body 110. An end of the elastic portion 142 is connected to the upper embedded ring portion 144. A combination of the upper embedded ring portion 144, the engaging ring portion 146, and the lower embedded ring portion 148 extends generally along the circumferential direction of the socket main body 110. The label ring 150 further includes a ring main body 151 and an inner bump 153. The convex portion 152 protrudes outward from the ring main body 151. The inner bump 153 protrudes inward from the ring main body 151. The sleeve 160 is disposed in the cavity of the socket main body 110 and has a generally annular shape. The sleeve 160 includes a first portion and a second portion connected to each other in the axial direction. The second portion is located behind the first portion. A diameter of the first portion of the sleeve 160 is smaller than a diameter of the second portion of the sleeve 160. The stem 170 is disposed in the cavity of the socket main body 110, and a portion of the stem 170 is surrounded by the sleeve 160. The spring 180 is disposed in the cavity of the socket main body 110 and surrounds the stem 170.

Reference is made again to FIG. 2. As shown in FIG. 2, in this embodiment, the first rubber ring RG1 and the second rubber ring RG2 are embedded in the cavity of the socket main body 110. The third rubber ring RG3 is disposed on the stem 170. The fourth rubber ring RG4 is disposed at a rear end of the socket main body 110. The fifth rubber ring RG5 is disposed on the socket rear terminal 120.

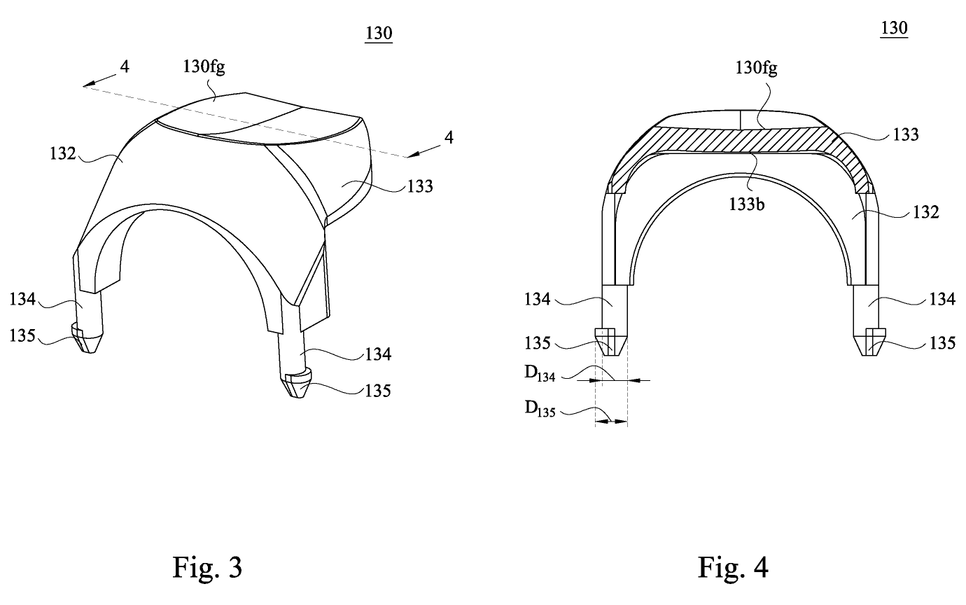

Reference is made to FIG. 3. FIG. 3 is a perspective view of a pressing part 130 in accordance with an embodiment of the present disclosure. As shown in FIG. 3, in this embodiment, the pressing part 130 further includes an expanding portion 135. Specifically, the pressing part 130 includes two latches 134 located on two sides of the pressing main body 132, and the expanding portion 135 is located at an end of the latch 134. In some embodiments, the expanding portion 135 is located at an end of the latch 134 away from the pressing main body 132. As shown in FIG. 3, a portion of the expanding portion 135 protrudes outward relative to the latch 134.

Reference is made to FIG. 4. FIG. 4 is a cross-sectional view of the pressing part 130 based on a section 4-4 of FIG. 3 in accordance with an embodiment of the present disclosure. As shown in FIG. 4, in this embodiment, the tongue portion 133 further has a bottom surface 133b. The bottom surface 133b of the tongue portion 133 is configured to allow the clip ring 140 to abut against. The arc surface 130fg is recessed toward the bottom surface 133b. In other words, a curvature center of the arc surface 130fg is located over the arc surface 130fg. As shown in FIG. 4, in some embodiments, the arc surface 130fg is line-symmetrical. For example, the arc surface 130fg is left-right symmetrical. The latch 134 has a generally cylindrical shape and has a diameter D₁₃₄. The expanding portion 135 has a diameter D₁₃₅. Specifically, the diameter D₁₃₅ refers to a diameter at where the expanding portion 135 and the latch 134 connects, and represents a maximum diameter of the expanding portion 135. In some embodiments, the diameter D₁₃₅ of the expanding portion 135 is greater than the diameter D₁₃₄ of the latch 134. This allows the pressing part 130 to be engaged with the engaging groove 112 by the latch 134 and the expanding portion 135.

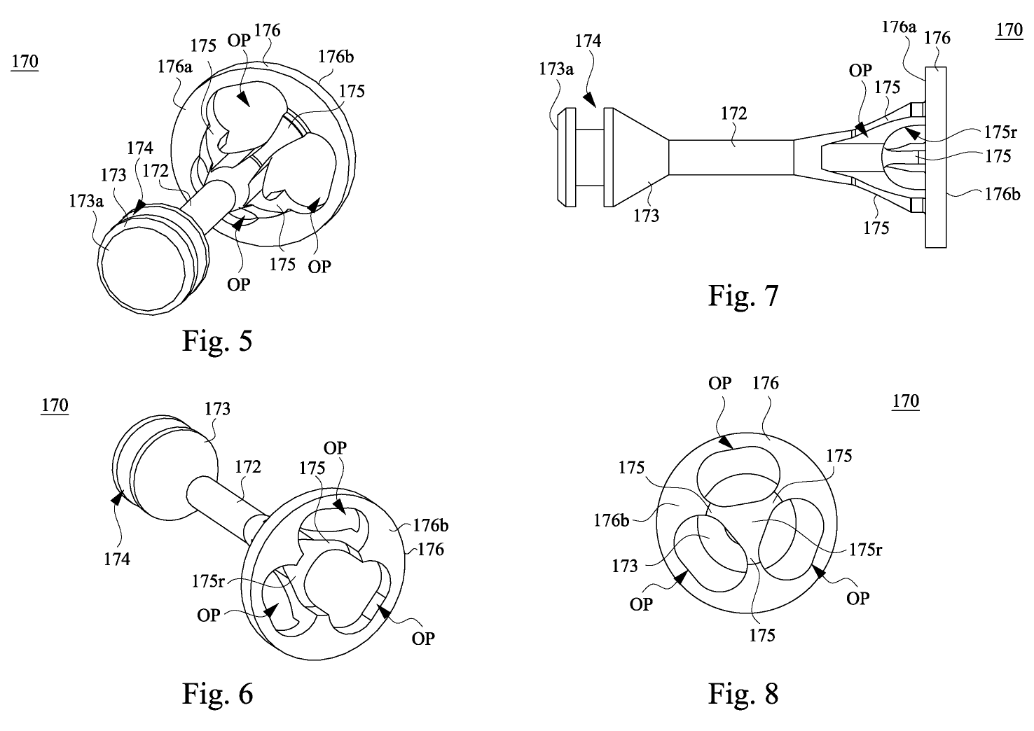

Reference is made to FIGS. 5 to 8. FIGS. 5 and 6 are perspective views of the stem 170 in accordance with an embodiment of the present disclosure. FIG. 7 is a sided view of the stem 170 in accordance with an embodiment of the present disclosure. FIG. 8 is a rear view of the stem 170 in accordance with an embodiment of the present disclosure. As shown in FIGS. 5 to 7, in this embodiment, the stem 170 includes a stem body 172, a stem head 173, a stem head groove 174, a plurality of arc-shaped supporting bones 175, and an abutting bottom portion 176. The stem body 172 is elongated in the axial direction. The stem head 173 is disposed at an end of the stem body 172 and has the stem head groove 174. The stem head groove 174 is located at a middle section of the stem head 173. A diameter of the stem head 173 in the radial direction is greater than a diameter of the stem body 172 in the radial direction. Specifically, the diameter of the stem head 173 gradually increases along a direction away from the stem body 172. The stem head 173 further has a front surface 173a located at an end of the stem head 173 away from the stem body 172. The plurality of arc-shaped supporting bones 175 extend from the other end of the stem body 172. Each of the arc-shaped supporting bones 175 extends away from the stem body 172 in both the axial direction and the radial direction of the socket main body 110. Specifically, the arc-shaped supporting bones 175 extend outward radially while extending away from the stem body 172 axially. The abutting bottom portion 176 is connected to the plurality of arc-shaped supporting bones 175. Specifically, the abutting bottom portion 176 has a generally disc-shaped structure. The abutting bottom portion 176 has a front surface 176a and a rear surface 176b. The arc-shaped supporting bones 175 are connected to the front surface 176a of the abutting bottom portion 176.

Reference is made again to FIGS. 7 and 8. As shown in FIGS. 7 and 8, in this embodiment, a domed surface 175r is formed on a side of the arc-shaped supporting bones 175 away from the stem body 172, and the domed surface 175r is located in front of the front surface 176a of the abutting bottom portion 176. In other words, the domed surface 175r is located between the stem body 172 and the abutting bottom portion 176. In some embodiments, the domed surface 175r is not coplanar with the front surface 176a. More specifically, a curvature center of the domed surface 175r is located on a side of the domed surface 175r away from the stem body 172. In some embodiments, the curvature center of the domed surface 175r is located between the domed surface 175r and the front surface 176a.

Reference is made again to FIGS. 5 to 8. As shown in FIGS. 5 to 8, in this embodiment, the stem 170 has a plurality of fluid passageway openings OP. Specifically, each of the fluid passageway openings OP is jointly defined by every two of the arc-shaped supporting bones 175 and the abutting bottom portion 176. As shown in FIG. 7, two arc-shaped supporting bones 175 and the abutting bottom portion 176 define the fluid passageway opening OP, and in a sided view, the fluid passageway opening OP has a generally pointed arch shape. As shown in FIG. 8, in a rear view, the fluid passageway opening OP has a generally oval shape. Specifically, a projection of the fluid passageway opening OP on the rear surface 176b of the abutting bottom portion 176 is generally oval. The design of the stem 170 helps reduce fluid resistance encountered when the fluid flows through the stem 170.

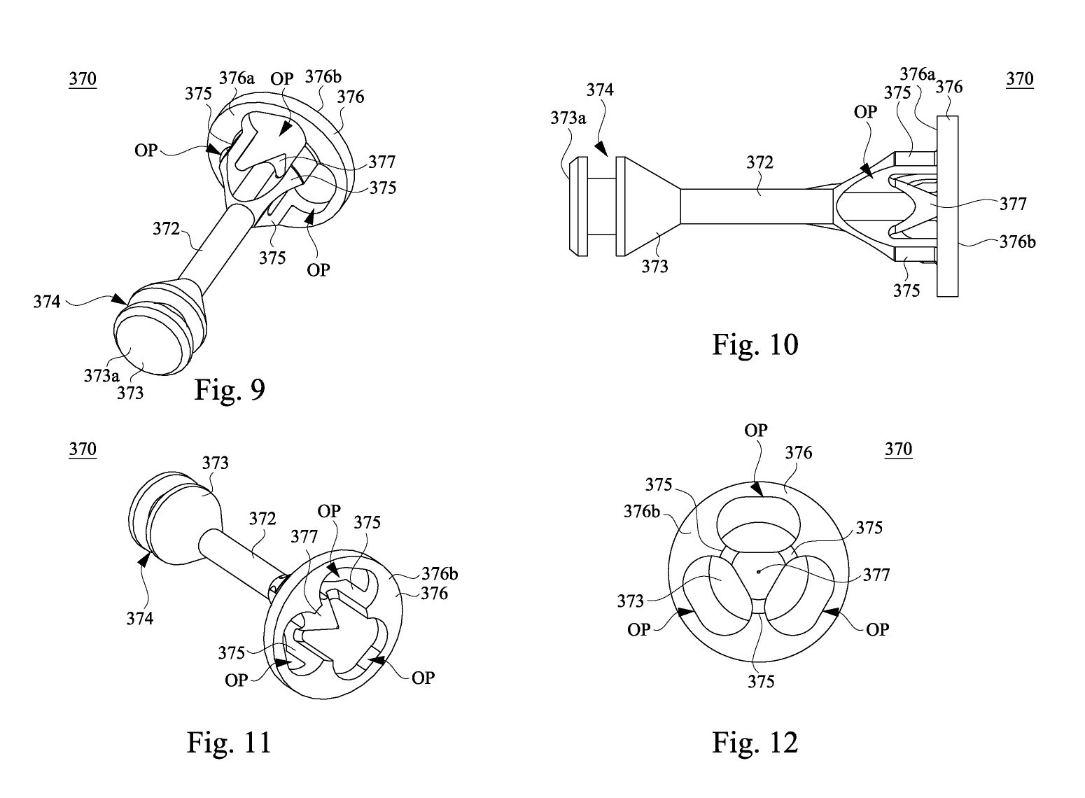

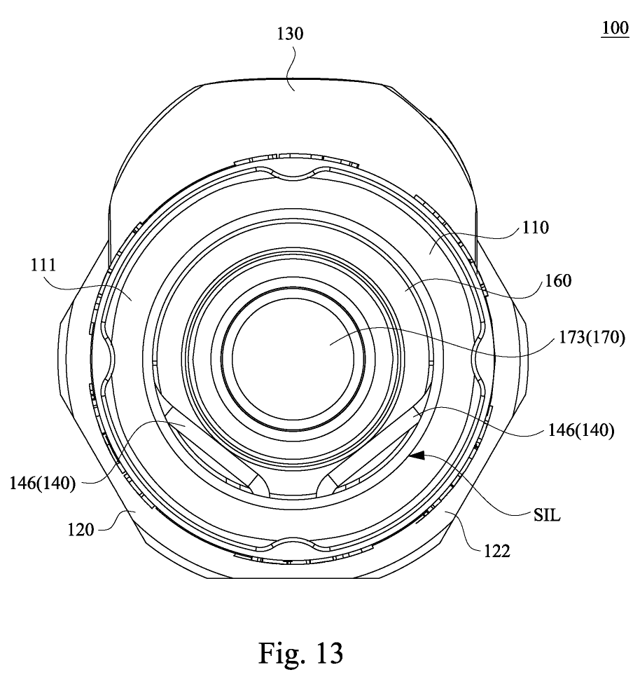

Reference is made to FIGS. 9 to 12. FIGS. 9 and 10 are perspective views of a stem 370 in accordance with another embodiment of the present disclosure. FIG. 11 is a sided view of the stem 370 in accordance with another embodiment of the present disclosure. FIG. 12 is a rear view of the stem 370 in accordance with another embodiment of the present disclosure. As shown in FIGS. 9 to 11, in this embodiment, the stem 170 of the socket 100 may also be implemented as the stem 370. Since the structural configuration of the stem 370 is generally similar to the structural configuration of the stem 170, only the differences will be described in detail below. In addition to including a stem body 372, a stem head 373, a stem head groove 374, a plurality of arc-shaped supporting bones 375, and an abutting bottom portion 376, the stem 370 further includes a cone body 377. The stem head 373 has a stem head groove 374. The stem head 373 further includes a front surface 373a at an end of the stem head 373 away from the stem body 372. The abutting bottom portion 376 includes a front surface 376a and a rear surface 376b. The cone body 377 is disposed on an end of the stem body 372 where the arc-shaped supporting bones 375 are connected and extends away from the stem body 372. In some embodiments, an apex of the cone body 377 is located between the stem body 372 and the abutting bottom portion 376. In some other embodiments, the apex of the cone body 377 and the abutting bottom portion 376 are coplanar.

Reference is made again to FIGS. 9 to 12. As shown in FIGS. 9 to 12, in this embodiment, the stem 370 includes a plurality of fluid passageway openings OP. In the side view, each of the fluid passageway openings OP has a generally pointed arch shape. As shown in FIG. 12, in the rear view, each of the fluid passageway openings OP has a generally oval shape. Specifically, a projection of each of the fluid passageway openings OP on the rear surface 376b of the abutting bottom portion 376 is generally oval. A projection of the cone body 377 on the rear surface 376b of the abutting bottom portion 376 generally passes through a central portion of the abutting bottom portion 376. The design of the stem 370 also helps reduce resistance encountered by fluid flowing through the stem 370.

Reference is made to FIG. 13. FIG. 13 is a front view of the socket 100 in accordance with an embodiment of the present disclosure. As shown in FIG. 13, in this embodiment, the stem head 173 of the stem 170 and the sleeve 160 are both located in the socket main body 110, and the sleeve 160 surrounds the stem head 173 of the stem 170. A width of the polygonal structure 122 of the socket rear terminal 120 in the radial direction is greater than a width of the socket main body 110 in the radial direction. The engaging ring portion 146 of the clip ring 140 is exposed in the cavity of the socket main body 110. Specifically, in a front view, only the engaging ring portion 146 of the clip ring 140 is visible. The elastic portion 142 of the clip ring 140 is invisible due to being shielded by the pressing part 130, and the upper embedded ring portion 144 and the lower embedded ring portion 148 of the clip ring 140 are invisible due to being shielded by the socket main body 110.

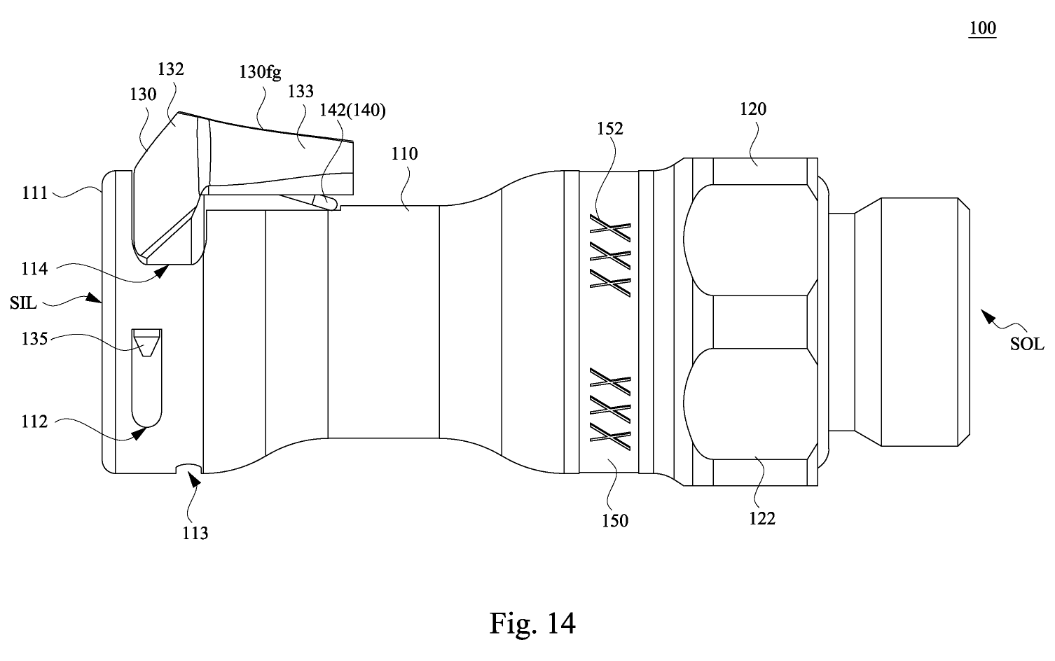

Reference is made to FIG. 14. FIG. 14 is a sided view of the socket 100 in accordance with an embodiment of the present disclosure. As shown in FIG. 14, in this embodiment, the pressing main body 132 of the pressing part 130 is located over the clip ring 140. The tongue portion 133 of the pressing part 130 is located over the elastic portion 142 of the clip ring 140. The through slot 114 accommodates the pressing part 130. Specifically, the pressing main body 132 of the pressing part 130 passes through the through slot 114, and the expanding portion 135 of the pressing part 130 passes through the engaging groove 112 and is exposed. As shown in FIG. 14, the engaging groove 112 is located closer to the front end surface 111 than the clip ring groove 113. A lowest portion of the clip ring groove 113 is recessed from the outer surface 110so of the socket main body 110.

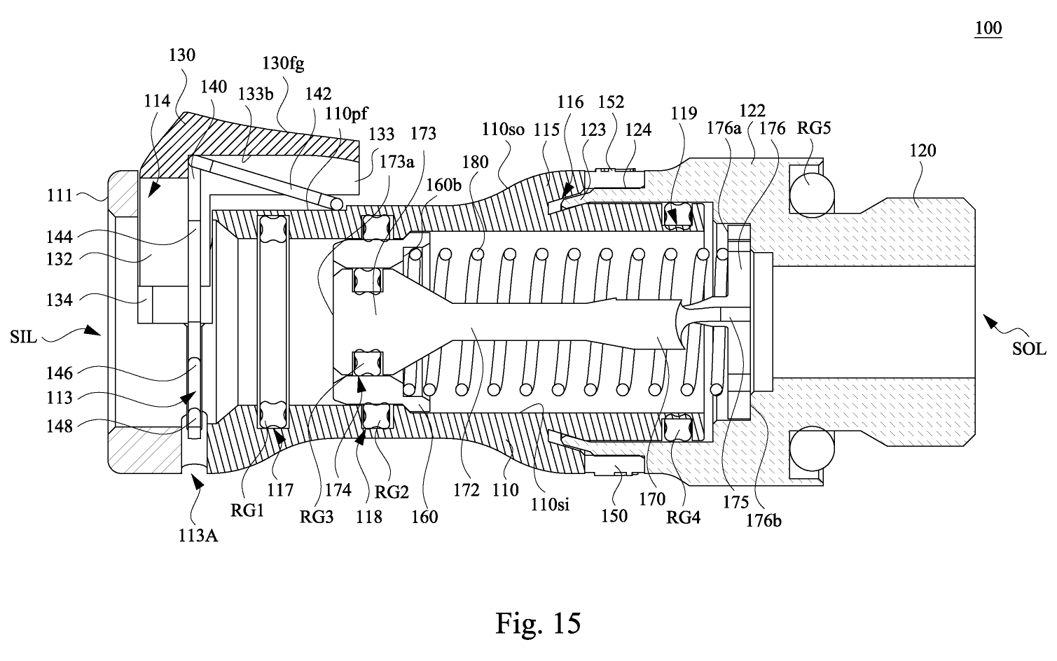

Reference is made to FIG. 15. FIG. 15 is a cross-sectional view of the socket 100 based on a section 15-15 of FIG. 1 in accordance with an embodiment of the present disclosure. As shown in FIG. 15, in this embodiment, the socket main body 110 further has an inner groove 116, a front accommodating groove 117, a rear accommodating groove 118, and an outer accommodating groove 119. The inner groove 116 is defined by a recessed portion between the eaves portion 115 and the socket main body 110. In other words, the inner groove 116 is located directly below the eaves portion 115. The front accommodating groove 117 and the rear accommodating groove 118 are recessed from the inner surface 110si of the socket main body 110 and extend in the circumferential direction. The front accommodating groove 117 is located in front of the rear accommodating groove 118 and behind the clip ring groove 113. The front accommodating groove 117 accommodates the first rubber ring RG1, and the rear accommodating groove 118 accommodates the second rubber ring RG2. The outer accommodating groove 119 is recessed from the outer surface 110so of the socket main body 110, and is located near a rear end of the socket main body 110 and behind the rear accommodating groove 118. The outer accommodating groove 119 accommodates the fourth rubber ring RG4. The clip ring groove 113 includes a through portion 113A located at a bottom portion of the clip ring groove 113. The through portion 113A runs through the socket main body 110 and is configured to accommodate the lower embedded ring portion 148 of the clip ring 140.

As shown in FIG. 15, the first rubber ring RG1 and the second rubber ring RG2 are disposed on the inner surface 110si of the socket main body 110. In some embodiments, a distance between the first rubber ring RG1 and the front end surface 111 is less than a distance between the second rubber ring RG2 and the front end surface 111.

Reference is made again to FIG. 15. As shown in FIG. 15, in this embodiment, the tapering portion 123 of the socket rear terminal 120 is located in the inner groove 116, while the tapering circumferential surface 124 of the socket rear terminal 120 is not located in the inner groove 116. The label ring 150 is disposed on the tapering circumferential surface 124. The elastic portion 142 of the clip ring 140 is located outside the cavity of the socket main body 110, while the upper embedded ring portion 144, the engaging ring portion 146, and the lower embedded ring portion 148 of the clip ring 140 are located inside the cavity of the socket main body 110. An end of the elastic portion 142 connected to the upper embedded ring portion 144 abuts against the pressing part 130, and the other end of the elastic portion 142 away from the upper embedded ring portion 144 abuts against the outer surface 110so of the socket main body 110. In some embodiments, an end of the elastic portion 142 abuts against the bottom surface 133b of the tongue portion 133, and the other end of the elastic portion 142 abuts against the horizontal surface 110pf of the socket main body 110. In some embodiments, the upper embedded ring portion 144 is located in the through slot 114.

Reference is made again to FIG. 15. As shown in FIG. 15, in this embodiment, the sleeve 160 sleeves the stem head 173 of the stem 170. The third rubber ring RG3 is disposed in the stem head groove 174 of the stem head 173. The sleeve 160 is located between the second rubber ring RG2 and the third rubber ring RG3, and the sleeve 160 simultaneously contacts both the second rubber ring RG2 and the third rubber ring RG3. A distance between the third rubber ring RG3 and the front end surface 111 is less than a distance between the second rubber ring RG2 and the front end surface 111. In other words, the second rubber ring RG2 and the third rubber ring RG3 are staggered in the axial direction. This results in less axial resistance encountered by the sleeve 160 when compared with a condition in which the second rubber ring and the third rubber ring are coplanar. The front surface 173a of the stem head 173 extends parallel with a front surface of the sleeve 160. The abutting bottom portion 176 of the stem 170 abuts against an inner surface of the socket rear terminal 120 by rear surface 176b. In other words, the abutting bottom portion 176 is located behind a rearmost end of the socket main body 110. Two ends of the spring 180 respectively abut against the sleeve 160 and the stem 170. Specifically, the two ends of the spring 180 respectively abut against the abutting surface 160b of the sleeve 160 and the front surface 176a of the abutting bottom portion 176. The abutting surface 160b is located at a step formed by a variation in inner diameter of the sleeve 160. Accordingly, the sleeve 160 can be reciprocally moved relative to the stem 170 by the spring 180, while the stem 170 remains stationary. The fifth rubber ring RG5 is disposed behind the polygonal structure 122.

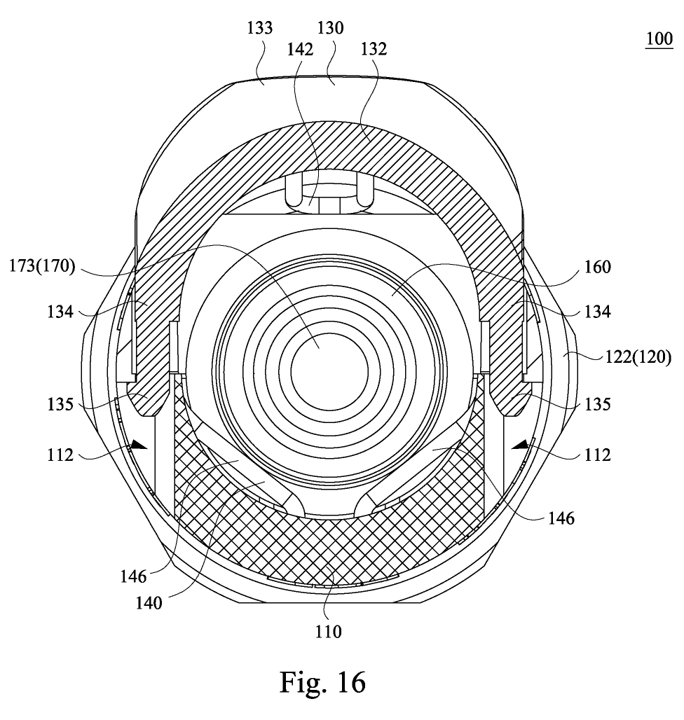

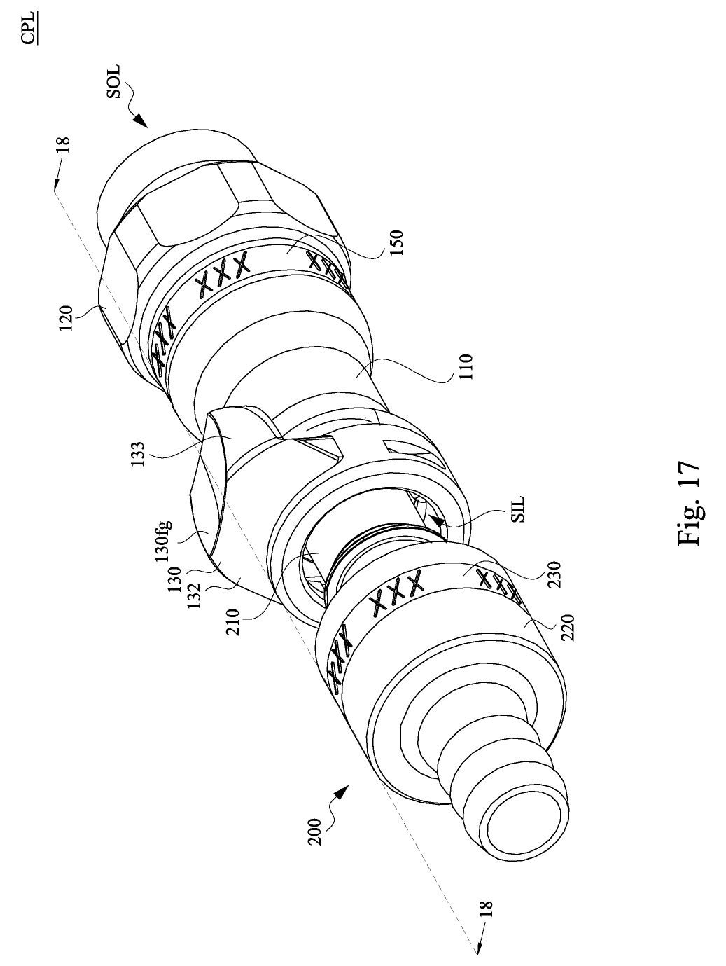

Reference is made to FIG. 16. FIG. 16 is a cross-sectional view of the socket 100 based on a section 16-16 of FIG. 1 in accordance with an embodiment of the present disclosure. FIGS. 16 and 13 both show a front view. As shown in FIG. 16, in this embodiment, the engaging groove 112 accommodates the latch 134 and the expanding portion 135. Since the engaging groove 112 has a step in a vertical direction, the expanding portion 135 can be limited in the engaging groove 112 by the step.

Hereinafter, the structure and function of each component included in a coupling assembly CPL of this embodiment and the connection relationship between the components will be described in detail.

Reference is made to FIG. 17. FIG. 17 is a perspective view of a coupling assembly CPL in accordance with an embodiment of the present disclosure. As shown in FIG. 17, in this embodiment, the coupling assembly CPL includes the aforementioned socket 100 and a plug 200. The plug 200 is coupled with the socket 100. Specifically, the plug 200 enters the cavity of the socket 100 through a front opening SIL of the socket 100. The plug 200 includes a plug main body 210, a plug rear terminal 220, and a label ring 230. The plug main body 210 is accommodated in the cavity of the socket main body 110. The plug rear terminal 220 is connected to the plug main body 210 and is located behind the plug main body 210. The label ring 230 is disposed between the plug main body 210 and the plug rear terminal 220.

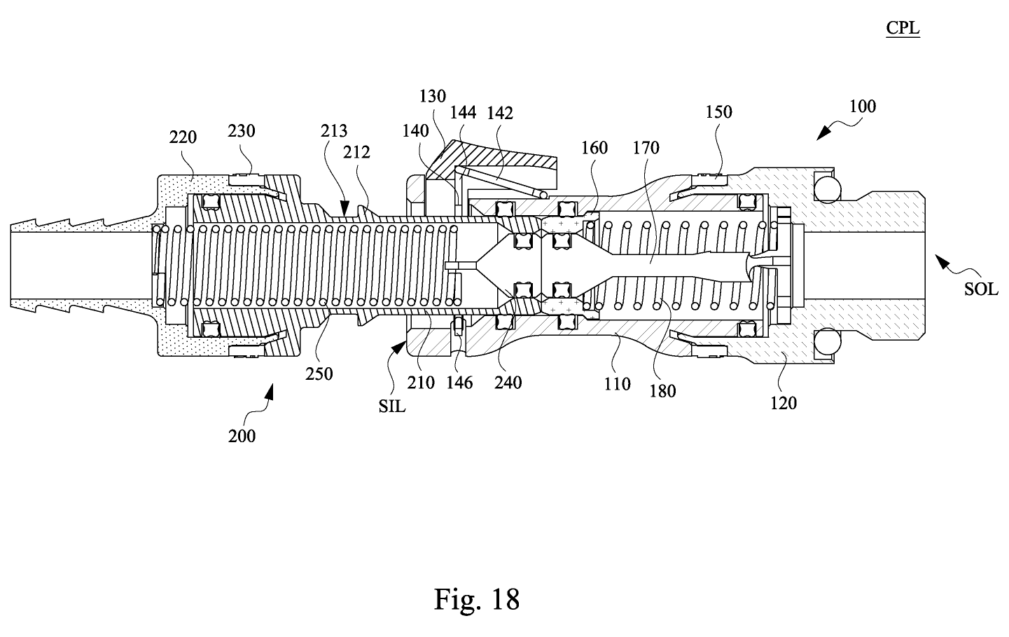

Reference is made to FIG. 18. FIG. 18 is a cross-sectional view of the coupling assembly CPL based on a section 18-18 of FIG. 17 in accordance with an embodiment of the present disclosure. As shown in FIG. 18, in this embodiment, the plug 200 further includes a circumferential hook 212, a circumferential engaging groove 213, a piston 240, and a spring 250. The circumferential hook 212 protrudes from an outer surface of the plug main body 210. The circumferential engaging groove 213 is located behind the circumferential hook 212. The piston 240 is located in a cavity of the plug main body 210. The piston 240 is located at a frontmost end of the plug main body 210. Two ends of the spring 250 respectively abut against the piston 240 and an inner surface of the plug rear terminal 220.

In a usage scenario, when the coupling assembly CPL is in a state shown in FIG. 14, the plug main body 210 of the plug 200 abuts against the sleeve 160 of the socket 100, and the piston 240 of the plug 200 abuts against the stem 170. Next, when a user operates the socket 100 and the plug 200 to move toward each other, the piston 240 abuts against the stationary stem 170, such that the plug main body 210 of the plug 200 pushes the sleeve 160 to move axially, and the sleeve 160 moves toward the rear opening SOL of the cavity and is disengaged from the second rubber ring RG2 and the third rubber ring RG3. Meanwhile, the piston 240 is detached from a front end of the plug main body 210, and both the spring 180 and the spring 250 are elastically compressed. Subsequently, when the user continues to move the socket 100 and the plug 200 further toward each other, the circumferential hook 212 contacts the engaging ring portion 146 of the clip ring 140, and the clip ring 140 moves downward due to the engaging ring portion 146 guided by an inclined surface of the circumferential hook 212. Next, when the engaging ring portion 146 passes over the inclined surface of the circumferential hook 212 and reaches the circumferential engaging groove 213, the clip ring 140 returns to its original position and is tightly engaged with the circumferential engaging groove 213, thereby completing the coupling between the socket 100 and the plug 200.

Conversely, as shown in FIGS. 13 and 14, when the user intends to separate the socket 100 and the plug 200 from each other, the user may press the arc surface 130fg of the pressing part 130 with a fingertip, causing the clip ring 140 to move downward. As a result, the engaging ring portion 146 of the clip ring 140 is no longer located in a range of the cavity in the axial direction, thereby allowing the plug main body 210 to disengage from the socket 100 without being blocked by the engaging ring portion 146.

From the above detailed description of the specific embodiments of the present disclosure, it can be clearly seen that in the socket and the coupling assembly of the present disclosure, since the two ends of the elastic portion of the clip ring respectively abut against the socket main body and the pressing part, the engaging ring portion can move along with the pressing part under the positional limitation of the clip ring groove when the user presses or releases the pressing part, and the engaging ring portion returns to its original position when the pressing part is released, thereby securely being engaged with the plug. In the socket and the coupling assembly of the present disclosure, since the socket includes a first rubber ring located in front of the socket main body, when the plug main body enters the cavity of the socket main body, it can be limited by the first rubber ring, thereby facilitating the alignment of the plug main body with the sleeve inside the cavity. In the socket and the coupling assembly of the present disclosure, since the distance between the third rubber ring and the front end surface of the socket main body is less than the distance between the second rubber ring and the front end surface of the socket main body, the second rubber ring and the third rubber ring are axially positioned on different planes. As such, when the sleeve moves axially between the second rubber ring and the third rubber ring, the resistance applied to the sleeve by the second rubber ring and the third rubber ring is relatively low, thereby reducing the user’s effort during coupling of the socket and the plug. In the socket and the coupling assembly of the present disclosure, since the pressing part has an arc surface located on a side thereof away from the socket main body, user comfort can be enhanced when the pressing part is pressed by a fingertip. In the socket and the coupling assembly of the present disclosure, since the arc-shaped supporting bones of the stem extend outward in both the radial direction and the axial direction, fluid (e.g., coolant) flowing through the cavity encounters reduced resistance, thereby increasing the flow coefficient. In conclusion, the socket and coupling assembly of the present disclosure not only ensures a secure engagement between the socket and the plug, but also enhances user convenience during plug-and-unplug operations.

Although the present disclosure has been described in considerable detail with reference to certain embodiments thereof, other embodiments are possible. Therefore, the spirit and scope of the appended claims should not be limited to the description of the embodiments contained herein.

It will be apparent to those skilled in the art that various modifications and variations can be made to the structure of the present disclosure without departing from the scope or spirit of the disclosure. In view of the foregoing, it is intended that the present disclosure cover modifications and variations of this disclosure provided they fall within the scope of the following claims.

What is claimed is:

1. A socket having a cavity, a front opening and a rear opening located at opposite ends of the cavity, comprising:
a socket main body having a through slot running through the socket main body, wherein the front opening defines a front end surface of the socket main body; and
a stem disposed in the cavity, the stem comprising:
a stem body elongated in an axial direction of the socket main body;
a stem head disposed at an end of the stem body and having a stem head groove;
a plurality of arc-shaped supporting bones extending from the other end of the stem body, each of the arc-shaped supporting bones extending away from the stem body in the axial direction and a radial direction of the socket main body; and
an abutting bottom portion connected to the arc-shaped supporting bones, wherein every two of the arc-shaped supporting bones and the abutting bottom portion jointly define a fluid passageway opening.

2. The socket of claim 1, further comprising:
a socket rear terminal connected to the socket main body; and
a label ring disposed on the socket rear terminal and located between the socket rear terminal and the socket main body.

3. The socket of claim 1, wherein the socket main body further has a clip ring groove recessed from an inner surface of the socket main body.

4. The socket of claim 3, further comprising:
a pressing part disposed on the socket main body and movably accommodated in the through slot; and
a clip ring disposed on the socket main body and movably accommodated in the clip ring groove, the clip ring comprising an elastic portion located outside the cavity and an engaging ring portion located inside the cavity,
wherein the elastic portion has opposite ends arranged along the axial direction of the socket main body, and an end of the elastic portion abuts against the pressing part and the other end of the elastic part abuts against an outer surface of the socket main body.

5. The socket of claim 4, wherein the pressing part comprises:
a pressing main body located over the clip ring;
a tongue portion extending from the pressing main body and located over the elastic portion;
a latch extending from the pressing main body and engaged with the socket main body; and
an expanding portion located at an end of the latch, wherein a diameter of the expanding portion is greater than a diameter of the latch.

6. The socket of claim 5, wherein the socket main body further comprises an engaging groove accommodating the latch and the expanding portion.

7. The socket of claim 4, wherein the pressing part has an arc surface located on a side of the pressing part away from the socket main body.

8. The socket of claim 1, further comprising:
a first rubber ring and a second rubber ring disposed on an inner surface of the socket main body, wherein a distance between the first rubber ring and the front end surface is less than a distance between the second rubber ring and the front end surface; and
a third rubber ring disposed in the stem head groove, wherein a distance between the third rubber ring and the front end surface is less than the distance between the second rubber ring and the front end surface.

9. The socket of claim 1, wherein the arc-shaped supporting bones form a domed surface on a side thereof away from the stem body, and the domed surface is located between the stem body and the abutting bottom portion.

10. The socket of claim 1, wherein the stem further comprises a cone body disposed at an end of the stem body connected to the arc-shaped supporting bones and extending away from the stem body, wherein an apex of the cone body is located at an end of the cone body away from the stem body.

11. A coupling assembly, comprising:
a socket having a cavity, a front opening and a rear opening located at opposite ends of the cavity, comprising:
a socket main body having a through slot running through the socket main body, wherein the front opening defines a front end surface of the socket main body; and
a stem disposed in the cavity, the stem comprising a stem body elongated in an axial direction of the socket main body, a stem head disposed at an end of the stem body and having a stem head groove, a plurality of arc-shaped supporting bones extending from the other end of the stem body, and an abutting bottom portion connected to the arc-shaped supporting bones, wherein each of the arc-shaped supporting bones extends away from the stem body in the axial direction and a radial direction of the socket main body, and every two of the arc-shaped supporting bones and the abutting bottom portion jointly define a fluid passageway opening; and
a plug coupled with the socket, comprising:
a plug main body accommodated in the cavity of the socket main body;
a circumferential hook protruding from an outer surface of the plug main body; and
a circumferential engaging groove located behind the circumferential hook.

12. The coupling assembly of claim 11, further comprising:
a socket rear terminal connected to the socket main body; and
a label ring disposed on the socket rear terminal and located between the socket rear terminal and the socket main body.

13. The coupling assembly of claim 11, wherein the socket main body further has a clip ring groove recessed from an inner surface of the socket main body.

14. The coupling assembly of claim 13, further comprising:
a pressing part disposed on the socket main body and movably accommodated in the through slot; and
a clip ring disposed on the socket main body and movably accommodated in the clip ring groove, the clip ring comprising an elastic portion located outside the cavity and an engaging ring portion located inside the cavity,
wherein the elastic portion has opposite ends arranged along the axial direction of the socket main body, and an end of the elastic portion abuts against the pressing part and the other end of the elastic part abuts against an outer surface of the socket main body.

15. The coupling assembly of claim 14, wherein the pressing part comprises:
a pressing main body located over the clip ring;
a tongue portion extending from the pressing main body and located over the elastic portion;
a latch extending from the pressing main body and engaged with the socket main body; and
an expanding portion located at an end of the latch, wherein a diameter of the expanding portion is greater than a diameter of the latch.

16. The coupling assembly of claim 15, wherein the socket main body further comprises an engaging groove accommodating the latch and the expanding portion.

17. The coupling assembly of claim 14, wherein the pressing part has an arc surface located on a side of the pressing part away from the socket main body.

18. The coupling assembly of claim 11, further comprising:
a first rubber ring and a second rubber ring disposed on an inner surface of the socket main body, wherein a distance between the first rubber ring and the front end surface is less than a distance between the second rubber ring and the front end surface; and
a third rubber ring disposed in the stem head groove, wherein a distance between the third rubber ring and the front end surface is less than the distance between the second rubber ring and the front end surface.

19. The coupling assembly of claim 11, wherein the arc-shaped supporting bones form a domed surface on a side thereof away from the stem body, and the domed surface is located between the stem body and the abutting bottom portion.

20. The coupling assembly of claim 11, wherein the stem further comprises a cone body disposed at an end of the stem body connected to the arc-shaped supporting bones and extending away from the stem body, wherein an apex of the cone body is located at an end of the cone body away from the stem body.
